(19) United States
(12) Patent Application Publication
(10) Pub. No.: US 2013/0203463 A1
(43) Pub. Date: Aug. 8, 2013

(54) POWER CONTROL MODULE

(71) Applicants: Steven David Kent, Yate (GB); Rudolf Frederick Reinsch, Yate (GB)

(72) Inventors: Steven David Kent, Yate (GB); Rudolf Frederick Reinsch, Yate (GB)

(73) Assignee: TRACKING IN MOTION LIMITED, Bristol (GB)

(21) Appl. No.: 13/806,299

(22) PCT Filed: Jun. 17, 2011
(86) PCT No.: PCT/GB2011/000923

§ 371 Date: Mar. 7, 2013

(30) Foreign Application Priority Data
Jun. 24, 2010 (GB) 1010674.8

(51) Int. Cl. H04W 52/02

(52) U.S. Cl. CPC H04W 52/0261
USPC 455/556.1

(57) ABSTRACT

A control module (12) for a battery-powered data gathering apparatus (10) in which a microcontroller (18) selectively activates and deactivates components in the apparatus in a power saving manner. By controlling power consumption, the control module may maximise the working lifetime of the cell (14) (e.g. battery) which provides power. In one aspect, the microcontroller is operable as a host controller for a USB cellular modem, whereby the control module enables a conventional cell to power periodic communications from a USB cellular modem. The microcontroller activates the USB interface only when it is required, thereby closely controlling power consumed by the USB interface and its corresponding connected device.

### FIELD OF THE INVENTION

The invention relates to a control module for controlling the power consumption of a battery-powered electronic device. For example, the invention is applicable to data gathering apparatus arranged periodically to communicate gathered data wirelessly to a remote destination.

### BACKGROUND TO THE INVENTION

Remote data gathering and communication systems are known. Typically such systems comprise a plurality of remote data collecting devices arranged to receive data input, e.g. from a user or an external sensor. The data collecting devices can communicate the received data to a central location, e.g. to provide a status overview and/or to alert management to any problems.

One example of such a system is a cleaning management system which permits cleaners to confirm a regular cleaning schedule by inputting data to data collecting devices situated at the locations to be cleaned. The remote data collecting devices in this example may also act as display units for indicating the current status.

Another example of such a system is a remote meter checking system in which the data collecting devices are arranged automatically to read an electricity, gas or water meter and communicate the reading to a remote location (e.g. a central server belonging to a utility or to a customer's mobile telephone) using the GSM wireless communication network.

As the geographic coverage provided by cellular networks expands, so the use of wireless communication techniques to transmit data collected at remote locations becomes an increasingly useful option for such data gathering systems. The advantages over systems that require wired connections are immediately clear.

### SUMMARY OF THE INVENTION

At its most general, the present invention proposes a control module for a battery-powered data gathering apparatus in which a microcontroller selectively activates and deactivates components in the apparatus in a power saving manner. By controlling power consumption, the control module may maximise the working lifetime of the cell (e.g. battery) which provides power. In one aspect of the invention, the control module enables a conventional cell to power periodic communications from a USB cellular modem for over a year before the cell needs replacing or recharging. Herein a conventional cell may exclude a lithium-ion type cell. The conventional cell may be a primary lithium cell, a zinc-carbon cell, a zinc-chloride cell, a nickel-cadmium cell and an alkaline cell. For example, the cell may be a collection of standard AA cells.

Thus, according to one aspect of the invention, there may be provided a control module for a battery-powered data gathering apparatus that is arranged periodically to communicate gathered data wirelessly to a remote destination, the control module comprising: a power input for receiving power from a cell; a Universal Serial Bus (USB) interface for connecting to a USB wireless communication device (e.g. USB cellular modem); a switching unit connected between the power input and the USB interface; and a microcontroller operably connected to the USB interface and the switching unit, wherein: the microcontroller is arranged to generate a USB control signal for the switching unit, the switching unit is arranged to selectively activate the USB interface based on the USB control signal, and the microcontroller is operable as a host controller for the USB cellular modem. With this arrangement the microcontroller may be able to activate the USB interface only when it is required. Accordingly, the power consumed by the USB interface and its corresponding connected device can be closely controlled, and preferably minimised. This is in contrast to conventional USB wireless connection devices, where power is supplied continuously when connected.

Herein the phrase “the microcontroller is arranged to” may mean that the microcontroller stores software instructions in an internal memory thereof, which, when executed, carry out the function described. Similarly, the phrase “the microcontroller is operably connected to” may mean that the microcontroller is capable of communicating command signals for operating a device to which it is connected.

Herein “microcontroller” means a central processing unit on a single integrated circuit. By using a microcontroller, the invention presents less of a power burden on the cell than a conventional processing chipset, e.g. found in a PC The remote destination may be a server or other device (e.g. mobile telephone) capable of receiving a wireless communication either directly or via the internet.

The USB interface may be a conventional USB port having a pair of data communication lines connected to the microcontroller. The USB interface may comprise a USB host controller separate from the microcontroller, but preferably the USB interface is integrally formed with the microcontroller. For example, the AVR microcontroller AT90USB64/128 manufactured by Atmel Corporation may be used.

The USB interface may be suitable for connection to any USB-based device capable of wireless communication. Herein, wireless communication may be via a wireless connection to the internet (e.g. using Wi-Fi or WiMAX) via a wireless modem, or via a mobile telecommunication link (e.g. using 3G, GPRS or any new generation programmable USB communication device) via a cellular modem. A USB cellular modem may be preferred for remote locations where internet access is limited.

In the invention, the microcontroller is arranged to act as the host controller for the USB wireless communication device, e.g. USB cellular modem. In other words, the microcontroller may have software stored thereon capable of directly controlling the USB wireless communication device. Conventional USB wireless communication devices are typically controlled by a software driver (eg PC's) installed on processing devices which consume more power than a microcontroller, so this arrangement has the advantage of saving power consumption.

In a practical embodiment, a USB wireless communication device may be arranged to “auto-install” its software driver. The microcontroller of the present invention may be arranged to bypass the software driver by generating a suitable control signal for the USB wireless communication device. For example, the control signal may switch the USB wireless communication device into a mode in which it is receptive to data for wireless transmission. The microcontroller itself may be arranged to generate data in a format suitable for wireless transmission to the internet e.g. using PPP or TCP/IP protocols.

The microcontroller may also be responsible for managing, e.g. controlling storage and reproduction of, the data collected by the data gathering apparatus. Thus, the control module may further comprise: a data input port for receiving data from a data collection device and transferring the received data to the microcontroller; and a memory unit connected to the power input via the switching unit and communicable with the microcontroller to receive data for storage and transmit stored data, wherein: the microcontroller is arranged to generate a memory control signal for the switching unit, and the switching unit is arranged to selectively activate the memory unit based on the memory control signal. Similarly to the USB interface discussed above, with this arrangement the microcontroller may be able to activate the memory unit only when it is required. Accordingly, the power consumed by the memory unit can be closely controlled, and preferably minimised. The memory unit may comprise a flash memory. For example, the AT25DF021 serial interface flash memory device manufactured by Atmel Corporation may be used.

The data input port may be for example a RS-232 port. The data collection device may be any type of transducer capable of transforming an external signal, e.g. from a user, sensor or the like, into an electronic data signal for the microcontroller. For example, the data collection device may be an RFID reader, an optical sensor, a manually activatable switch, a proximity (e.g. iButton) reader or the like. The data collection device may be self-powered. The microcontroller may be arranged to execute a predetermined routine upon receipt of an electronic data signal from the data input port, e.g. an electronic data signal representing a change of state in the data collection device. The predetermined routine may include generating a memory control signal to activate the memory unit, calling a time-stamp from the clock, storing a payload of the electronic data signal and the time-stamp in the memory of the memory unit, and generating a memory control signal to deactivate the memory unit.

Each data entry received at the microcontroller from the data input port may be time-stamped. The time-stamp may be generated by the data collection device, but is preferably generated by a clock operably connected to the microcontroller. The microcontroller may be arranged to call current date and time information from the clock.

The control module may further comprise a timing unit (which may be the same as or separate from the clock) that is operable to transmit a trigger signal to the microcontroller, wherein the microcontroller is arranged to control the switching unit based on the trigger signal. The trigger signal may be used as an alarm signal to wake the microcontroller from a sleep mode. Since the microcontroller may consume less power in a sleep mode, this arrangement may also facilitate a reduction in power consumption. The timing unit may be programmable by the microcontroller to set the timing of the trigger signal. The microcontroller may be arranged to enter a sleep mode after the programming the timing unit to transmit a future trigger signal.

The timing unit may be arranged to transmit a plurality of trigger signals according to a predetermined schedule, the predetermined schedule being programmable via the microcontroller. For example, the collected data may need to be transmitted periodically to the remote destination; the trigger signals transmitted according to the predetermined schedule may prompt the microcontroller to execute a routine to perform this task. The periodic trigger signals may be distinct from the alarm trigger signal. Indeed, they may be produced by different devices. However, preferably the functions of the clock and timing unit (both to generate periodic trigger signals and alarm trigger signals) are performed by a single unit, e.g. the R2023K/T clock manufactured by Ricoh Company, Ltd. An advantage of using a single unit is that the power consumption is minimised. Preferably the clock/timing unit draw a current of less than 1 μA (more preferably less than 0.5 μA) in use.

The switching unit may be arranged to permit independent activation/deactivation of the USB interface and memory unit. This function may be achieved by connected the USB interface, the memory unit and the microcontroller on respective parallel power lines that extend from the power input, wherein the switching unit may comprise a USB switching element on the power line to the USB interface and a memory switching element on the power line of the memory unit. The USB switching element and the memory switching element may both be selectively activatable voltage regulators, wherein the USB control signal and the memory control signal are enable/disable signals for the voltage regulator associated with the USB interface and memory unit respectively. A microcontroller voltage regulator may also be attached on the power line to the microcontroller. If the microcontroller voltage regulator is selectively activatable, it may be locked in an always ON configuration. Separate switches may be used in the switching unit, but it is advantageous to combine the functions of voltage regulation and switching in a single component to reduce the overall component count and total power consumption for the device. According to another aspect of the invention, there may be provided data gathering apparatus for periodically communicating gathered data wirelessly to a remote destination, the apparatus comprising: a cell; a USB wireless communication device (e.g. USB cellular modem) for communicating wirelessly with the remote destination; a data collection device; and a control module connected to receive power from the cell, the control module comprising: a USB interface for connecting to the USB wireless communication device; a switching unit connected between the cell and the USB interface; and a microcontroller operably connected to the USB interface, the switching unit and data collection device, wherein: the microcontroller is arranged to: receive data from the data collection device; and generate a USB control signal for the switching unit; the switching unit is arranged to selectively activate the USB interface based on the USB control signal, and when the USB interface is activated, the microcontroller is operable as a host controller for the USB cellular modem to transmit the received data to the USB cellular modem for communication to the remote destination. The features of the control module discussed above may also be applied to this aspect. For example, the cell may be a collection of conventional AA batteries (e.g. primary lithium or alkaline or rechargeable nickel-cadmium).

Preferably, the data gathering apparatus has a memory unit connected to the cell via the switching unit and communicable with the microcontroller to receive data for storage and transmit stored data, wherein: the microcontroller is arranged to generate a memory control signal for the switching unit, and the switching unit is arranged to selectively activate the memory unit based on the memory control signal.

The microcontroller may be arranged to control the apparatus to adopt any one of:
a sleep mode, in which the switching unit is configured such that the USB interface and memory unit are deactivated;
a data collection mode, in which the switching unit is configured such that the USB interface is deactivated and the memory unit is activated to receive and store data; and
a data communication mode, in which the switching unit is configured such that the USB interface is activated to enable wireless communication with the remote destination via the USB cellular modem and the memory unit is activated to transmit stored data to the microcontroller.

When the sleep mode is adopted, the microcontroller may draws a current of less than 2 mA, preferably less than 6 μA.

The apparatus may include a timing unit operable to transmit a periodic sequence of trigger signals to the microcontroller, wherein the microcontroller is arranged to control the apparatus to adopt the data communication mode upon receiving the trigger signal. As above, the periodic sequence of trigger signals may be transmitted according to a predetermined schedule that is programmable via the microcontroller.

The microcontroller may be arranged to detect a change in status of the data collection device, and to control the apparatus to adopt the data collection mode upon detecting the change in status.

Preferably, the USB wireless communication device is a USB cellular modem, or a plug-and-play USB wireless communication dongle. As mentioned above, the microcontroller may be arranged to bypass the software driver that is installable upon connecting the dongle. The microcontroller may communicate directly with the plug-and-play USB wireless communication dongle using a protocol suitable for suitable for wireless communications.

The control module discussed above may form a “plug-in” unit for use in data collection devices having different applications. For example, the data collection device may incorporate a display and be used in a cleaning management system. In another example, the data collection device may be incorporated in to device for monitoring the turning of bed-ridden patients to reduce the risk of bed sores. In this case, the device may also include a display for indicating the time of the last patient turn and/or the time of or time until the next patient turn. Collecting data about patient turning and communicating it to a central location may facilitate the early identification of patients in need of attention and hence reduce the risk of bed sores occurring.

### BRIEF DESCRIPTION OF THE DRAWINGS

Embodiments of the invention are discussed in detail below with reference to the accompanying drawings, in which:

FIG. 1 is a schematic block diagram of a data gathering apparatus incorporating a control module that is an embodiment of the invention;

FIG. 2 is a schematic block diagram of a data gathering system incorporating a control module that is an embodiment of the invention;

FIG. 3 is a schematic block diagram of a switching unit for use in a control module according to the invention;

FIG. 4 is a schematic diagram of patient turn monitoring device that incorporates a control module according to the invention; and

FIG. 5 is a simplified circuit diagram of a control module that is an embodiment of the invention.

### DETAILED DESCRIPTION; FURTHER OPTIONS AND PREFERENCES

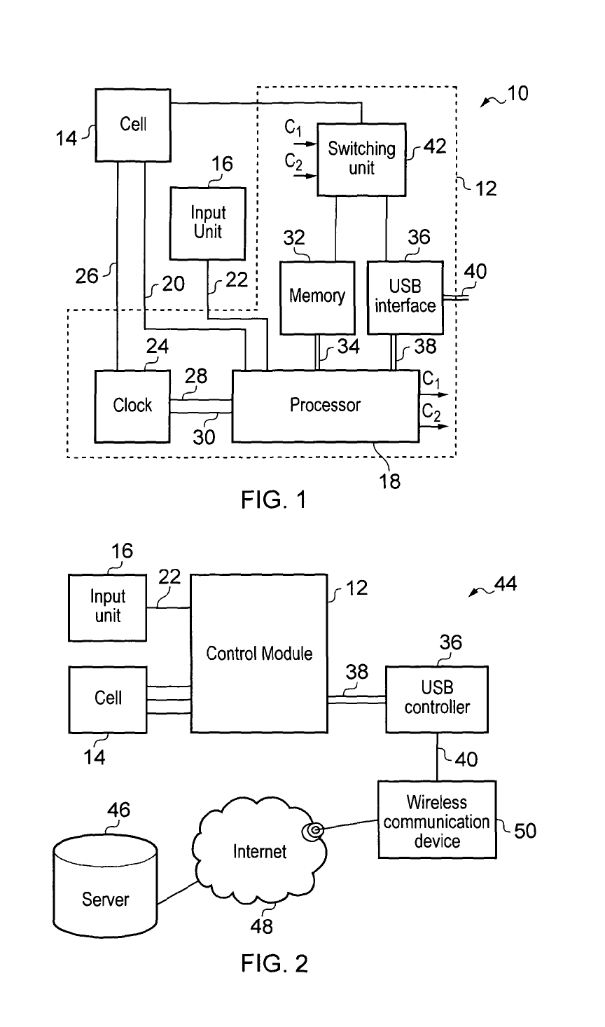

FIG. 1 is a block diagram showing the basic components of a data gathering apparatus 10 that incorporates a control module 12 that is an embodiment of the invention. The internal component of the control module 12 are contained within the dotted line shown in FIG. 1; the cell 14 and input unit 16 are external to the control module 12. The components of the control module 12 may be fabricated on to a single circuit board.

The control module 12 comprises a microcontroller 18 that is connected to receive power from the cell 14 via power line 20 and data from the input unit 16 via a data line 22. As mentioned above, the cell 14 may be a collection of (e.g. two or more, preferably three or more) series connected conventional AA batteries. In this embodiment, the cell has a voltage rating not less than 5V. The data line 22 may deliver the data to a I/O port on the microcontroller 18. The input unit 16 may be any device suitable for generating and transmitting a electronic data signal to the microcontroller 18. Preferably the input unit is automated (e.g. a sensor) or semi-automated (e.g. a ID reader).

The control module 12 further comprises a clock 24 which is powered by the cell 14 via power line 26 (which may be same as power line 20). The clock 24 communicates with the microcontroller 18 via signal line 28. The microcontroller 18 may request a time-stamp, i.e. a date and time reading, from the clock 24 via the signal line 28. The microcontroller 18 may also send commands for programming interrupt signals from the clock 24 via the signal line. The interrupt signals (discussed below) from the clock are sent to the microcontroller 18 along an interrupt line 30 that is separate from the signal line 28.

The control module 12 further comprises a memory unit 32 in communication with the microcontroller 18 via signal lines 34. The microcontroller 18 is arranged to transfer data into the memory unit 32 and receive requested data from the memory unit 32 via the signal line 34.

The control module 12 further comprises a USB interface 36 in communication with the microcontroller 18 via signal line 38. For example, the USB interface may be a conventional USB port, whereby the signal line 38 comprises a pair of data communication lines connected to the microcontroller. External link 40 represents the capability of the USB interface to connect to any USB-based device capable of wireless communication, e.g. a USB cellular modem.

Both the memory unit 32 and the USB interface 36 are connected to receive power from the cell via a switching unit 42. The switching unit 42 is arranged to switch power ON/OFF to the memory unit 32 and USB interface 36 based on control signals C₁ and C₂ generated by the microcontroller 18. The memory unit 32 and USB interface 36 are thus selectively activatable by the microcontroller 18. When they are deactivated, the power consumption of the control module is substantially reduced compared with when they are activated.

FIG. 2 shows the control module 12 connected in a data gathering system 44 in which a data gathering apparatus is capable of wirelessly communicating with a remote destination (server 46) via the internet 48. In this arrangement, a USB controller 36 is shown as a separate component to the microcontroller in the control module 12. However, it is preferred for the USB interface to be integrally formed with the microcontroller.

The USB controller 36 is connected to a USB-based wireless communication device 50, e.g. a USB cellular modem, which is capable of transmitting wireless communication signals to the server 46 via the internet 48 either directly via a wireless network link (e.g. Wi-Fi) or indirectly via mobile telecommunications (e.g. 3G).

This system may be characterised by the microcontroller being programmed to communicate directly with the wireless communication device 50 rather than via a separate software driver, e.g. that may be primed to auto-install upon insertion of the wireless communication device 50 into the USB port. In practice, the direct communication between the microcontroller and wireless communication device 50 is achieved by having software instructions stored on the microcontroller which, when executed, are capable of transforming payload data (e.g. extracted from the memory unit) into a format that complies with the communication protocol used by the wireless communication device 50.

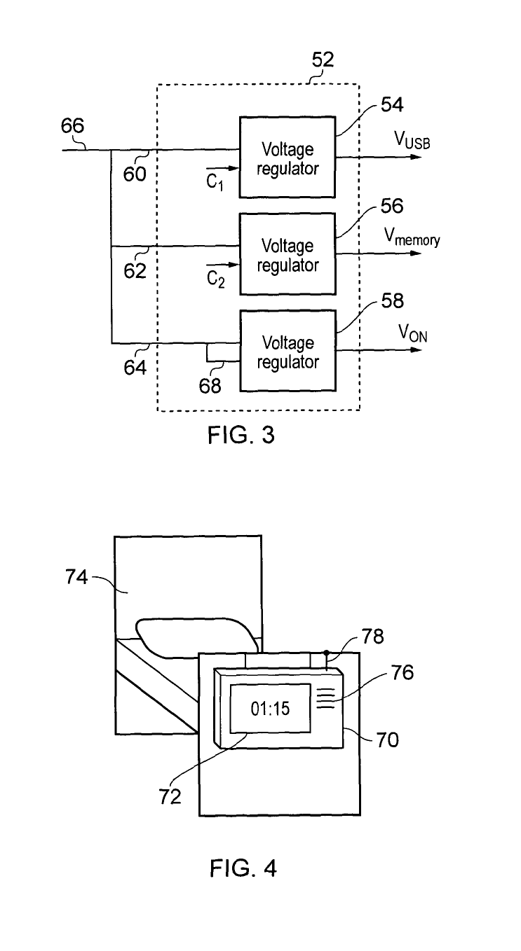

FIG. 3 shows a specific example of a switching unit 52 for a control module according to the invention. The switching unit 52 in this example differs from the switching unit 42 in FIG. 1 in that the power lines to all of the components in the control module, including the microcontroller and clock, pass though it. The switching unit 52 comprises three voltage regulators 54, 56, 58 connected in parallel on three respective signal paths 60, 62, 64 which are fed by a main power rail 66 connected to the cell (not shown). the voltage regulators 54, 56, 58 each generate a respective output power signal V_{USB}, V_{memory}, and V_{ON}. The voltage regulators 54, 56, 58 also each have an enable/disable input. When enabled, power from the cell is transferred as the output power signals V_{USB}, V_{memory}, and V_{ON}; when disabled, the output power signals V_{USB}, V_{memory}, and V_{ON} are substantially zero. Voltage regulator 58 supplies power to the microcontroller and clock, which are always on. According, the enable/disable input is locked into an always ON mode by receiving a signal 68 split from the signal path 64. The voltage regulator 54 is for the USB interface and receives control signal C₁ from the microcontroller at its enable/disable input. The voltage regulator 56 is for the memory unit and receives control signal C₂ from the microcontroller at its enable/disable input. With this arrangement, activation of the memory unit and the USB interface may be performed independently. This enables the microcontroller to perform routines which involve either one or both of the USB interface and memory unit. For example, a routine for storing data received from the input unit in the memory unit does not require the USB interface to be activated.

Examples of routines performed by the control module are now described. The microcontroller may be arranged to adopt a sleep mode by default, e.g. at the end of every scheduled routine and/or after a predetermined period of inaction is detected when the control module is not in the sleep mode. In the sleep mode, the memory unit and USB interface may be deactivated and the microcontroller in a quiescent state The power drawn from the cell in sleep mode may be primarily taken by the microcontroller and clock. The clock may draw a negligible amount (e.g. 1 μA or less) compared with the microcontroller, which preferably draws 6 μA or less. The microcontroller may execute routines which exit the sleep mode if:
a status change at the input unit is detected by the microcontroller;
a one-off (e.g. alarm) trigger signal is received from the clock; or
a periodic trigger signal is received from the clock.

A status change at the input unit may represent a data entry action or a manual instruction to transmit data to the remote destination. The microcontroller may be arranged to recognise the type of status change and choose an appropriate routine. Where the status change is a data entry action, the microcontroller may perform a routine having the following steps:
switching the microcontroller into an active state;
switching the control module into a data collection mode in which the memory unit is activated and the USB interface is deactivated by sending a control signal to the switching unit so that it provides power to the memory unit;
processing the electronic data signal received from the input unit to generate payload data for storing in the memory, including obtaining time-stamp information from the clock for inclusion in the payload data;
transmitting the payload data to the memory; and
switching the control module back to the sleep mode.

The microcontroller may write a history of its actions in an internal log.

The one-off trigger signal may represent preset alerts for the microcontroller, e.g. to access the remote server to check for updates, or to check that the connection to the input unit is working properly. The periodic trigger signals may represent a regular prompt to communication data gathered in the memory to the remote server. In this case, the microcontroller may perform a routine having the following steps:
switching the microcontroller into an active state;
switching the control module into a data communication mode in which the memory unit and the USB interface are activated by sending control signals to the switching unit so that it provides power to both the memory unit and the USB interface;
calling payload data stored in the memory;
processing the payload data into a format suitable for transmission;
forwarding the suitably formatted data to the USB interface for transmission via the USB wireless communication device;
receiving a validation message from the remote server;
clearing the memory of the sent payload data; and
switching the control module back to the sleep mode.

FIG. 4 shows another example of a data gathering apparatus 70 that incorporates a control module that is an embodiment of the invention. In this example, the apparatus includes a display screen 72 (e.g. an LCD screen or the like) and is adapted to be attached to the end of a bed 74 (e.g. a hospital bed). The display on the display screen may be controlled by the microcontroller in conjunction with the clock, e.g. to indicate the amount of time elapsed since the last recorded data entry. The apparatus 70 include a internal ID reader 74, e.g. a proximity reader, for a user to record a data entry representative of an event, e.g. turning a patient in the bed. The apparatus 70 includes an external antenna 78 for transmitting data from the USB wireless communication device (which is contained in the apparatus housing), but this is not essential.

The control module of the invention may also be used as a communications device in a host device, e.g. to permit a plurality of remote devices to be managed centrally. This may be particularly useful for devices such as vending machines, which can be located on premises that are not physically accessible at all times by the device owner. In this example, in addition to the power saving function described above, the control module may also serve as a means for updating firmware installed on the host device to control its operation. For example, the host device may have its own processor (e.g. CPU) and memory on which the operation firmware is stored and executed. Here, the microcontroller of the control module may be is communication with the CPU of the host device, e.g. to send and receive instructions and/or data. The control module may be arranged to request an update for the host device's firmware based on an instruction from the host device itself (e.g. via the CPU) or based on an internal predetermined alarm condition. The firmware update may be downloaded via the USB cellular modem and stored temporarily on the memory unit of the control module until the host device is ready to receive it.

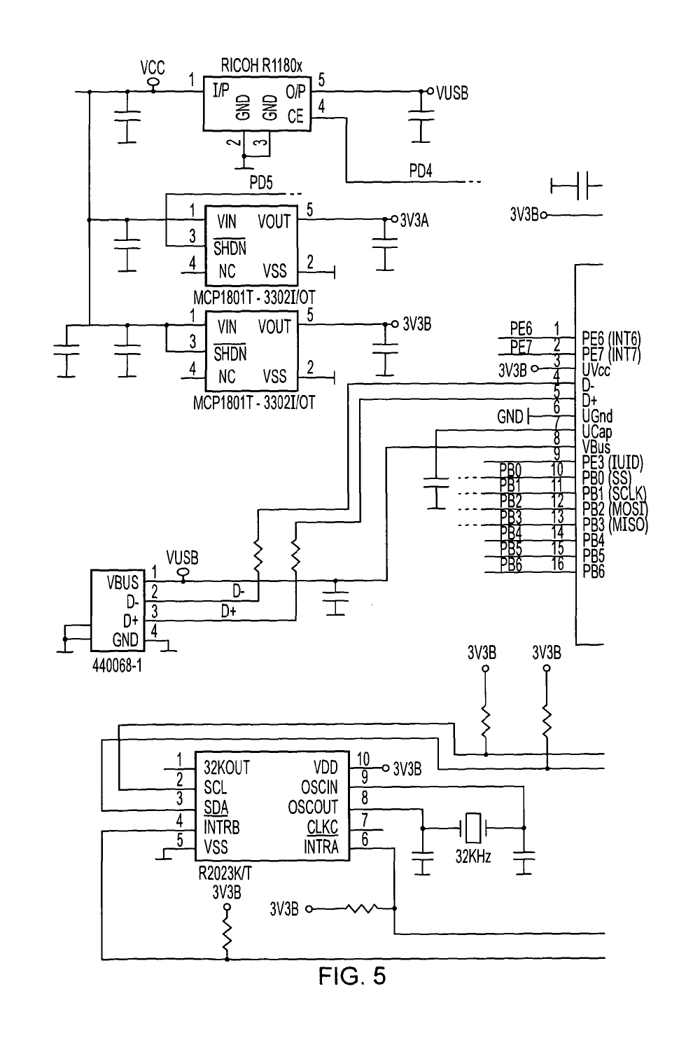

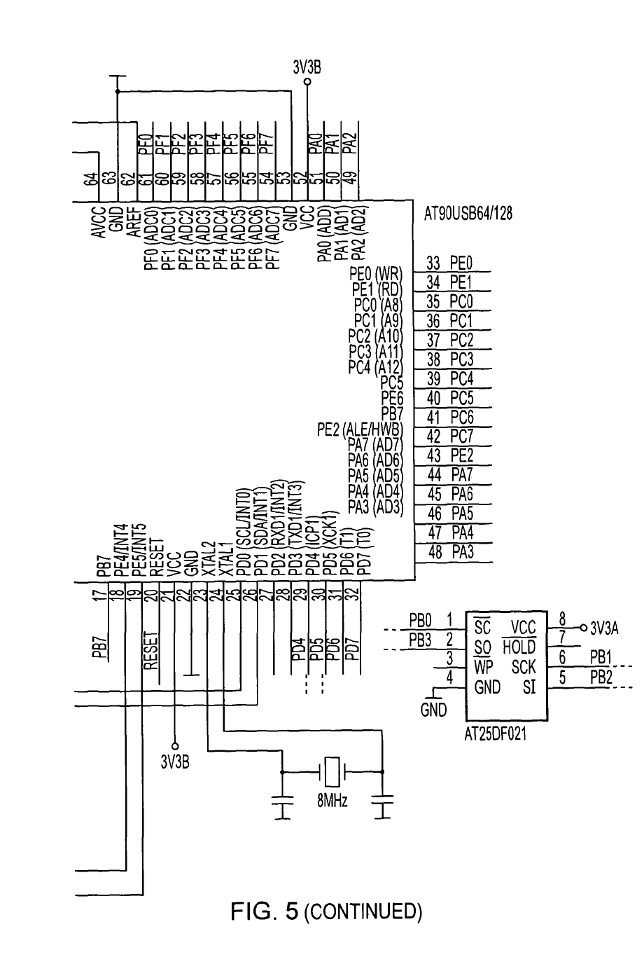

FIG. 5 shows a circuit diagram for the control module. One terminal of a cell (not shown) is connected to the VCC contact and the other terminal to the plurality of ground contacts. The switching unit is formed of three voltage regulators: a Ricoh R1180x device which outputs a signal VUSB for the USB interface, and two MCP1801T-33021/OT devices which output signals 3V3A and 3V3B. Signal 3V3A is for the memory unit. Signal 3V3B is for the microcontroller and clock. The voltage regulator producing signal 3V3B is locked into an always ON mode. The voltage regulator producing signal 3V3A is selectively activatable by signal line PD5 from the microcontroller. The Ricoh R1180x device is selectively activatable by signal line PD4 from the microcontroller.

The USB interface (component 440068-1) is connected to the microcontroller (component AT90USB64/128) by two data lines D−, D+.

The memory unit (component AT25DF021) is connected to the microcontroller by four signal lines PB0-PB3.

The clock (component R2023K/T) is connected to the microcontroller by two signal lines PD0, PD1 which permit two way communication therebetween, i.e. time-stamp information to be sent to the microcontroller and trigger signal programming commands to be sent to the clock. The trigger signals (interrupt signals) travel along two separate signal lines PE4, PE5.

1. A control module for a battery-powered data gathering apparatus that is arranged periodically to communicate gathered data wirelessly to a remote destination, the control module comprising:
a power input for receiving power from a cell;
a USB interface for connecting to a USB cellular modem;
a switching unit connected between the power input and the USB interface; and
a microcontroller operably connected to the USB interface and the switching unit,
wherein:
the microcontroller is arranged to generate a USB control signal for the switching unit,
the switching unit is arranged to selectively activate the USB interface based on the USB control signal, and
the microcontroller is operable as a host controller for the USB cellular modem.

2. A control module according to claim 1 further comprising:
a data input for receiving data from a data collection device and transferring the received data to the microcontroller; and
a memory unit connected to the power input via the switching unit and communicable with the microcontroller to receive data for storage and transmit stored data,
wherein:
the microcontroller is arranged to generate a memory control signal for the switching unit, and
the switching unit is arranged to selectively activate the memory unit based on the memory control signal.

3. A control module according to claim 1 or claim 2 further comprising:
a timing unit operable to transmit a trigger signal to the microcontroller,
wherein the microcontroller is arranged to control the switching unit based on the trigger signal.

4. A control module according to claim 3, wherein the timing unit is arranged to transmit a plurality of trigger signals according to a predetermined schedule, the predetermined schedule being programmable via the microcontroller.

5. A control module according to claim 3 or 4, wherein in operation the timing unit is connected to the power input and draws a current of less than 1 μA.

6. A control module according to claim 2, wherein the switching unit comprises a first selectively activatable voltage regulator connected between the power input and the USB interface, and a second selectively activatable voltage regulator connected between the power input and the memory unit, wherein the USB control signal and the memory control signal are enable/disable signals for the first and second selectively activatable voltage regulators respectively.

7. A data gathering apparatus for periodically communicating gathered data wirelessly to a remote destination, the apparatus comprising:
a cell;
a USB cellular modem for communicating wirelessly with the remote destination;
a data collection device; and
a control module connected to receive power from the cell, the control module comprising:
a USB interface for connecting to the USB cellular modem;
a switching unit connected between the cell and the USB interface; and
a microcontroller operably connected to the USB interface, the switching unit and data collection device,
wherein:
the microcontroller is arranged to:
receive data from the data collection device; and
generate a USB control signal for the switching unit;
the switching unit is arranged to selectively activate the USB interface based on the USB control signal, and
when the USB interface is activated, the microcontroller is operable as a host controller for the USB cellular modem to transmit the received data to the USB cellular modem for communication to the remote destination.

8. A data gathering apparatus according to claim 7 further comprising a memory unit connected to the cell via the switching unit and communicable with the microcontroller to receive data for storage and transmit stored data,
wherein:
the microcontroller is arranged to generate a memory control signal for the switching unit, and
the switching unit is arranged to selectively activate the memory unit based on the memory control signal.

9. A data gathering apparatus according to claim 8, wherein the microcontroller is arranged to control the apparatus to adopt any one of:
a sleep mode, in which the switching unit is configured such that the USB interface and memory unit are deactivated;
a data collection mode, in which the switching unit is configured such that the USB interface is deactivated and the memory unit is activated to receive and store data; and
a data communication mode, in which the switching unit is configured such that the USB interface is activated to enable wireless communication with the remote destination via the USB cellular modem and the memory unit is activated to transmit stored data to the microcontroller.

10. A data gathering apparatus according to claim 9, wherein when the sleep mode is adopted, the microcontroller draws a current of less than 6 μA.

11. A data gathering apparatus according to claim 9 further comprising a timing unit operable to transmit a periodic sequence of trigger signals to the microcontroller, wherein the microcontroller is arranged to control the apparatus to adopt the data communication mode upon receiving the trigger signal.

12. A data gathering apparatus according to claim 11, wherein the periodic sequence of trigger signals is transmitted according to a predetermined schedule that is programmable via the microcontroller.

13. A data gathering apparatus according to claim 9, wherein the microcontroller is arranged to detect a change is status of the data collection device, and to control the apparatus to adopt the data collection mode upon detecting the change in status.

14. A data gathering apparatus according to claim 7, wherein the USB cellular modem is a plug-and-play USB wireless communication dongle.

15. A data gathering apparatus according to claim 7, wherein the cell is any one or more of a lithium cell, a zinc-carbon cell, a zinc-chloride cell, a nickel-cadmium cell and an alkaline cell or any other suitable cell able to deliver power at a level suitable for operating the apparatus.
